(19) United States
(12) Patent Application Publication
(10) Pub. No.: US 2005/0025058 A1
(43) Pub. Date: Feb. 3, 2005

(54) Method for stochastic selection of improved cost metric backup paths in shared-mesh protection networks

(76) Inventors: Siddheswar Chaudhuri, East Brunswick, NJ (US); Eric Bouillet, Jersey City, NJ (US); Jean-Francois Labourdette, New York, NY (US); Suryanarayan Ramamurthy, Foster City, CA (US); Georgios Ellinas, Astoria, NY (US)

Correspondence Address: Jennifer Earley-Patent Administrator, 2 Crescent Place, P.O. Box 901, Oceanport, NJ, 07757, US

(21) Appl. No.: 10/628,964

(22) Filed: Jul. 30, 2003

(51) Int. Cl. H04L 12/26

(52) U.S. Cl. 370/238; 370/252; 370/254

(57) ABSTRACT

A method of path selection in shared-mesh restoration networks that results in efficient use of network resources, using only the network state information available locally at each network element. The method uses probability theory to develop an estimate of protection channel sharing opportunities and encourages sharing of protection channels if possible

### BACKGROUND OF THE INVENTION

1. Field of the Invention

This invention relates generally to the field of networking and in particular to methods of selecting and provisioning communications paths in shared-mesh protection communications networks.

2. Description of the Prior Art

Communications networks have been developed to provide communications services in the form of transmission of information carrying signals between ingress points and egress points of the network in a reliable and cost-efficient manner. Networks are comprised of a plurality of sets of communications equipment, or network elements, the bi-directional transmission links interconnecting them, and the software used to control signal propagation through the network. Each link is comprised of fibers and optical devices that enable the propagation between adjacent network elements of concurrent, uncorrelated optical channels. Signaling is in turn achieved by pulsing the channels at predetermined rates. Each signal traverses the network from source client equipment connected to its ingress network element to destination client equipment connected to its egress network element over a primary path comprised of a serial chain of network elements and links carrying channels. Since the amount of equipment and number of links determine the cost of the network, primary paths are typically kept as short as possible while still providing desired connectivity.

Unfortunately, network elements and transmission links, including those comprising primary paths, exhibit a variety of failure modes including equipment malfunction, software failure, and human failure that can result in loss of service between ingress and egress network elements. The impact of service interruption can be severe due to the amount of information carried on each signal in a typical modern network. As such, it is desirable to protect service by providing an alternate path for each signal, called the back-up path, that is used to carry the signal in the event of a failure on the signal's primary path.

One method to provide service protection is to dedicate a backup path for each primary path in the network. In such dedicated protection methods, the primary path and backup path both carry a copy of the signal at all times and the egress node continually monitors the signal and decides which copy to use on an on-going basis. Dedicated protection provides the fastest network restoration time but at high cost since the amount of equipment is at least twice that of an unprotected network.

An alternative method of network protection is shared-mesh protection, wherein the network elements and channels comprising backup paths can be used to protect multiple primary paths simultaneously. In such shared-mesh protection methods, a backup path does not carry live traffic until one of the primary paths it is protecting incurs a failure. Once a failure on a protected primary paths occurs, the network elements and channels of the backup path begin carrying the affected signal and the other primary paths protected by links in this backup path become unprotected until the network is reprovisioned.

The concept of Shared Risk Group (SRG) is described by Labourdette, Bouillet, Ramamurthy, EllinasChaudhuri, and Bala in a paper Routing Strategies for Capacity-Efficient and Fast Restorable Mesh Optical Networks,” which appeared in Photonic Network Communications, vol. 4, in July 2002, on pages 219 through 235, and also in a paper by Ellinas, Bouillet, Ramamurthy, Labourdette, Chaudhuri, and Bala, in a paper entitled “Routing and Restoration Architectures in Mesh Optical Networks,” in Optical Netwrok Magazine, vol. 4, in January 2003, on pages 91 through 106. As taught by these authors, each point of independent failure in a network is denoted by an SRG with an associated list that includes all paths that share that risk of failure. By way of example, a section of conduit containing links of multiple paths, multiple signal lines wrapped in a single cable, or multiple signal channels multiplexed onto a single signal line would be types of SRGs.

In order to avoid having a single failure event require two or more primary paths to obtain signal restoration from the same shared protection channel on a backup path link, all primary paths protected by the same shared protection channel must be SRG disjoint. Two or more primary paths are described as SRG disjoint if the sets of SRGs associated with each path have no common elements. Therefore, all prospective channels on proposed backup path links must not have any SRGs in common with the primary path seeking protection, and the primary path seeking protection must not have any SRGs in common with any primary paths already being protected by the prospective channels on the proposed backup path links.

Network control, the manner in which signals propagate through the network and the computation and provisioning of primary and backup paths, is provided by suites of network management software collectively known as the network controller. Control functionality can be affected either by means of a central control element that communicates with each network element directly or by distributed local control functions located at network element that communicate with each other on an as-needed basis.

In the case of a central control element, the control element maintains a database of all state variables describing (a) each network element and all links interconnecting them such as a list of links between adjacent nodes, the cost of using those links, the list of SRGs each link traverses, the number of available channels and their data rates between adjacent nodes, the number of shared channels reserved for protection, and their data rates between adjacent nodes, and (b) the provisioned primary and backup paths and corresponding channels, and the union set of all the SRG's traversed by all links of all primaries protected by each shared protection channel. The network controller communicates with each individual network element in order to provision new services, respond to changes in the network such as failures, and to maintain and update its database.

As the size of the network grows, the size and complexity of the database required to manage the network with a central controller becomes unmanageable. An alternative control method for large networks utilizing intelligent network elements and distributed control is described by Ramamurthy, Sengupta, and Chaudhuri in paper entitled “Comparison of Centralized and Distributed Provisioning of Paths in Optical Networks,” which appeared in The Technical Digest of the Optical Fiber Communication Conference, 2001 on pages MH4-1-3.

In the alternative, distributed control approach, a signal's ingress network element controls the computation of primary and backup paths to its intended egress network element. In contrast to a central control method wherein complete SRG information about every link in the entire network is available to the controller, in the distributed control method the information held at each network element about the SRGs in the network is a subset of the complete information. Specifically, SRG information is limited to the number of times each SRG is traversed by a primary path being protected by each shared protection channel in the network. Specifically, each network element holds a local database of state variables that include the links to adjacent network elements, the cost of using each link prorated for each channel carried on it, a list of SRGs each link traverses, the number and data rates of available channels between each pair of network elements, the number of shared protection channels between adjacent network elements, and the number of times each SRG in the network is traversed by a primary path protected by any shared protection channel in that link, where the set of SRGs traversed by each primary is the union set of SRGs traversed by all the links along that path.

In the distributed control method, the process used to compute primary and backup paths is an iterative one wherein the ingress network element designates a set of primary paths and subsequently requests each network element on those paths to propose a link to adjacent network elements on the paths. The proposed links are compared to the SRG of the primary and its SRGs. If commonality of SRGs is determined, the choice is invalid, and a request for another proposed link is made. This process continues until a valid link choice is identified or the list of potential candidates is exhausted.

Unfortunately, this iterative process is generally unsatisfactory for shared-mesh protection networks since the resulting networks typically require more network elements and links than necessary. Since the selection of backup paths is effectively a random process, the likelihood of an optimized selection of primary and backup paths is extremely low. A consequence of the non-optimal configuration is that additional transmission equipment is required, thus higher capital costs and greater latency during switching.

A need therefore exists of a method to compute sets of primary and backup channels in distributed-control, shared-mesh protection networks that is independent of network size.

### SUMMARY OF THE INVENTION

We have developed a method of path selection in shared-mesh restoration networks that results in efficient use of network resources, using only the network state information available locally at each network element. The method uses probability theory to develop an estimate of protection channel sharing opportunities and encourages sharing of protection channels if possible.

Viewed from a first aspect, our invention is a method of determining a set of primary and backup paths in a communications network that makes efficient use of available network resources without requiring a centralized controller or large complicated databases of state variables. It is a stochastic method that uses probability theory to estimate the ability to share proposed backup channels for each given proposed primary path without incurring contention problems. Our method is described by Bouillet, Labourdette, Ellinas, Ramamurthy, and Chaudhuri in a paper entitled “Stochastic Approaches to Route Shared Mesh Restored Lightpaths in Optical Mesh Networks,” in the Proceedings of the Conference on Computer Communications, in June 2002, on pages 801 through 807. Advantageously and according to our invention, backup links are efficiently shared thereby reducing the total amount of network resources, i.e. the cost, needed to attain a given capacity. Our inventive method employs signaling between network elements to provision the primary and backup paths once the lowest cost candidates have been determined. According to our invention, a set of shortest paths from an ingress network element to an egress network element is chosen as a candidate group of potential primary paths. For each potential primary path, the remainder of the set comprises its associated set of potential backup paths from which a designated backup path for that potential primary path is chosen. The designated backup path is selected based on channel sharing opportunity as estimated using our inventive method. For each potential primary path, our method uses the limited link information found locally at each network element to estimate for each link in each potential backup path the likelihood that the primary path under consideration is failure risk-diverse to the set of primary paths already being protected by that link, and thus the probability that a channel in this link can be shared. The estimate of the ability of the backup links to be shared is used to weight the cost associated with each link in the backup paths, which is further used to select the lowest cost backup path for each potential primary path. The resulting set of potential primary paths and their associated backup paths are then ordered from lowest to highest estimated cost. Signaling between the ingress network element and each network element in the proposed paths is then used to provision the lowest estimated cost path pair. If the lowest estimated cost pair can not be established, it is removed from the pool of candidates and the next lowest estimated cost pair is tried. This process continues until either a successful attempt is made or the pool of candidates is exhausted. If the candidate pool becomes exhausted, an error signal is returned to the network controller and the attempts cease.

Viewed from another aspect, our invention is directed to communications networks employing a stochastic method of path computation in order to reduce the amount of resources required to provide desired services. The provisioning of network paths according our inventive method can occur at any time, such as predetermined intervals, or at every new path provisioning event in order to attain and maintain efficient use of network resources.

### BRIEF DESCRIPTION OF THE DRAWINGS

FIG. 1a shows a shared mesh-restoration network with two established primary and backup path pairs;

FIG. 1b shows the network of FIG. 1a after the provisioning of a new primary and backup path pair;

FIG. 2 shows the steps involved in determining the probability that a channel in a backup path link can be shared with a proposed backup path;

FIG. 3 shows the steps involved in provisioning a path pair in connection with the probability method described in FIG. 2 according to the present invention;

FIG. 4 is a plot of the error distribution of the estimate probabilities minus experimental probabilities according to our inventive method for a large number of random topographical arrangements;

FIG. 5 is a plot of the error distribution of the exact probabilities obtained by computation according to our inventive method for a large number of random topographical arrangements;

FIG. 6 shows a summary of the results comparing the stochastic method according to our inventive method with a deterministic method as implemented in a centralized control topology;

FIG. 7 shows the distribution of sharing probabilities in a 100-node, 137-link network; and

FIG. 8 shows the distribution of sharing probabilities in a 220-node, 300-link network.

### DETAILED DESCRIPTION OF THE INVENTION

Our inventive method provides a cost-efficient means of making a connection between communications equipment connected to an ingress network element and communications equipment connected to an egress network element through a shared-mesh protection network utilizing distributed network control.

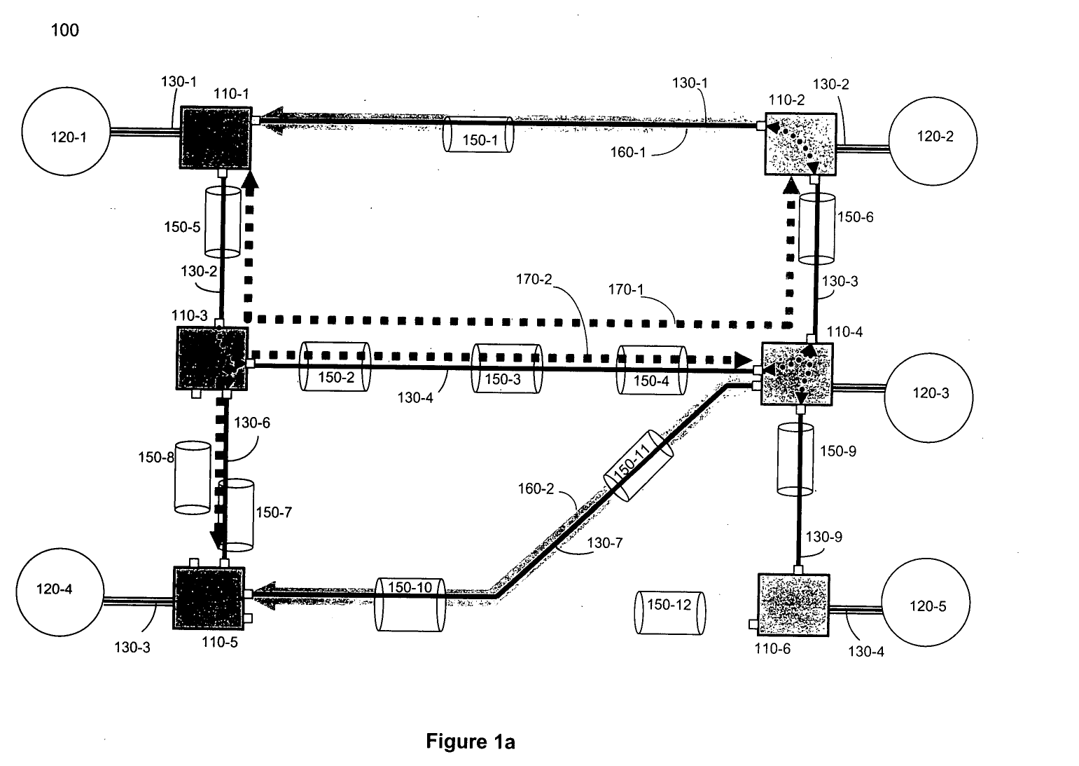

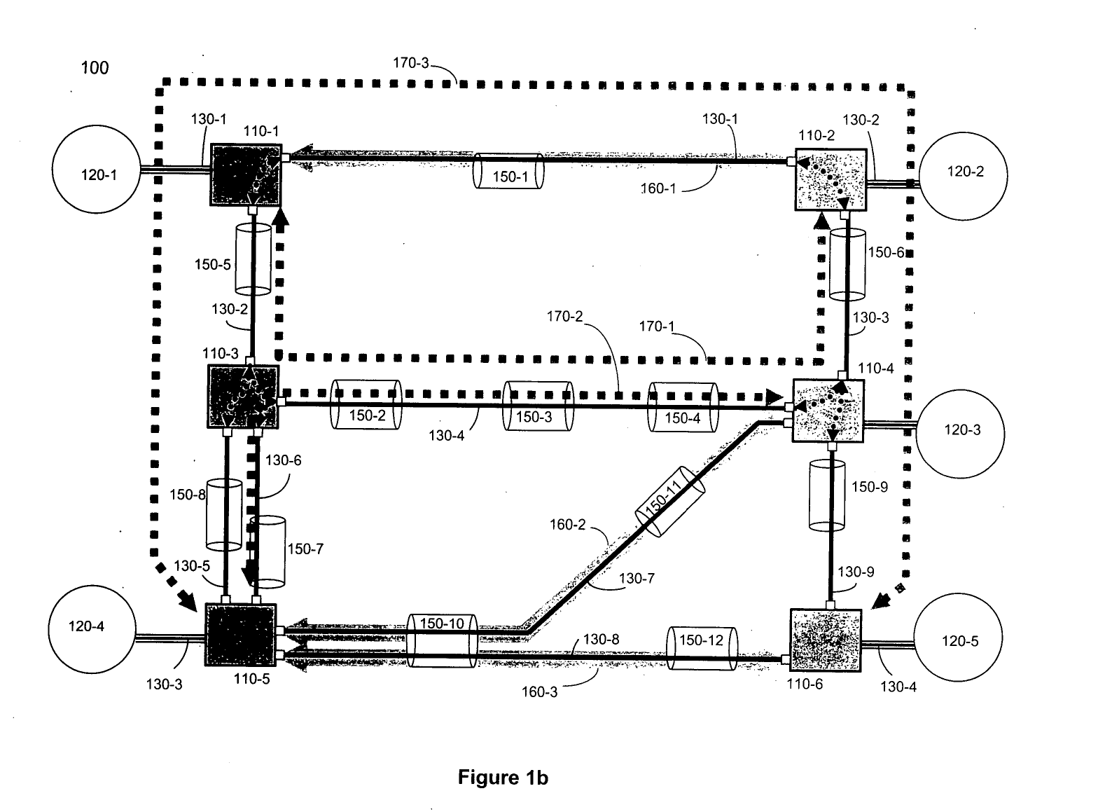

In order to better illustrate our invention, FIG. 1a depicts a mesh-connected network prior to provisioning new service and FIG. 1b depicts the same network after provisioning of new service according to our inventive method. In FIG. 1a, a primary path, 160-1, carries a bi-directional signal between a client equipment 120-1 connected to network element 110-1 and client equipment 120-2 connected to network element 110-2. Primary path 160-1 includes network element 110-1, link 130-1, and network element 110-2, and traverses shared-risk group (SRG) 150-1. Primary path 160-1 has an associated backup path 170-1, having network elements 110-1, 110-3, 110-4, 110-2, and links 130-2, 130-4, and 130-3, traversing SRGs 150-5, 150-2, 150-3, 150-4, and 150-6.

A second primary path, 160-2, carries a signal between client equipment 120-4 connected to network element 110-5 and client equipment 120-3 connected to network element 110-4. Primary path 160-2 is comprised of network element 110-5, link 130-7, and network element 110-4, and its link traverses SRGs 150-10 and 150-11. Separate SRGs 150-10 and 150-11 in link 130-7 are shown to demonstrate a commonly occurring situation wherein multiple SRGs relate to a single link, for example a transmission line travelling through multiple conduits. Primary path 160-2 has an associated backup path 170-2, which includes network elements 110-5, 110-3 110-4, and links 130-6 and 130-4, traversing SRGs 150-7, 150-2, 150-3, and 150-4.

Primary paths 160-1 and 160-2 are the shortest paths that achieve desired connectivity, requiring the least number of network elements and links and thus incurring the lowest cost.

Since the primary paths shown in FIG. 1a have no common SRGs, their respective backup paths are allowed to share equipment if desirable. In the case of backup paths 170-1 and 170-2, the shortest potential backup paths for each would include link 130-4, so they are shown sharing the resources of network elements 110-3, 110-4, and link 130-4.

FIG. 1b shows the provisioning of new service between client equipment 120-4 and 120-5 according to our preferred embodiment. A request for new service is generated by client equipment 120-4 and received by 110-5, the ingress network element for this service. The ingress node accesses a locally available database of state variables to develop a set of K shortest paths through the network interconnecting network elements 110-4 and 110-5. In this case, the maximum available value of K is equal to 4 and a complete set of potential primary paths can be denoted by the following list of paths wᵢ: where w₁={130-8}, w₂={130-7,130-9}, w₃={130-6,130-4, 130-9), and w₄={130-6,130-2,130-1,130-3,130-9}.

For each potential primary path in the set, proceeding from shortest to longest, a potential backup path is chosen from the remainder of the set according to our inventive method which employs a weighting scheme with the purpose of selecting the lowest weight backup path for each primary path. The weighting scheme assigns weighted costs to links in potential backup paths in a manner that encourages sharing of channels among multiple primary paths. Links contained in a prospective primary path or that are not SRG-disjoint with the prospective primary path are assigned an infinite weight. Links that do not have an available shared protection channel are assigned a weight corresponding to the real cost of adding a shared protection channel to that link. Links that have an available shared protection channel are assigned a weighted cost corresponding to the actual cost of that channel scaled by the probability that the channel can not be shared. Thus, the cost of a link that has a high sharing probability would be multiplied by a very low weight, giving it very low weighted cost. A link that has high probability of SRG contention with a primary path already being protected by that link would be assigned a weighted cost very close to its actual cost. The total cost of the paths are then estimated by adding the weighted costs of all the links contained therein.

In the example shown here, link 130-7 is assigned an infinite weighted cost due to a shared SRG 150-10 with the shortest primary path 160-3, and link 130-4 is assigned an infinite weighted cost due to its previously provisioned use as a backup path for primary path 160-2 that shares SRG 150-10 with potential primary path 150-3. As a result, paths w₂ and w₃ are assigned an infinite cost, removing them from consideration and leaving only w₁ and w₄ as viable paths for this connection.

Beginning with the path pair containing the shorter primary path {w₁,w₄}, the probability of allowed sharing of links in the backup path is computed using their SRG information known by network element 110-5 and a weighted cost of the path pair is determined. The process is repeated for all path pairs resulting in weighted cost estimates for all potential path pairs.

The weighted cost estimates are used to define a set of path pairs comprised of each potential primary path and its corresponding shortest, i.e. lowest cost, backup path. After ordering the path pairs from lowest cost, {w₁,w₄}, to highest cost, {w₄,w₁}, signaling between the ingress network element, 110-5, and all other network elements in the paths is used to attempt to provision the lowest cost path pair. If any link in either w₁ or w₄ can not be established, {w₁,w₄} is removed from consideration and the ingress network element attempts to provision the new lowest cost path pair, {w₄,w₁}. If the ingress element can not establish any of the path pairs in the set of candidates, an error message is transmitted to the client equipment that requested the service.

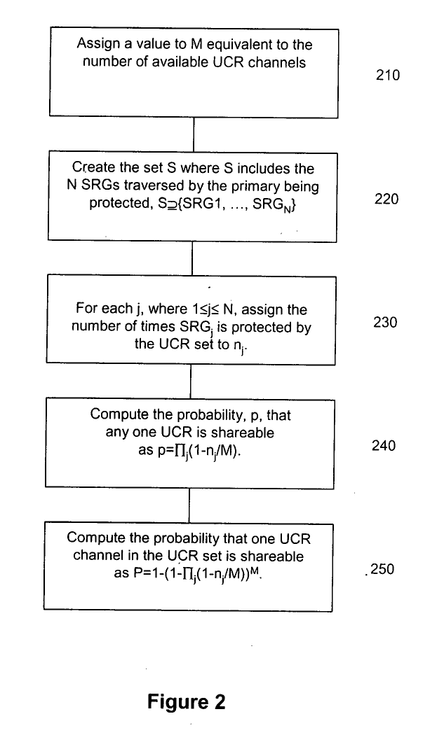

In one embodiment, our inventive method is used to compute a probability that a shared protection channel in a backup link can be shared as described in FIG. 2. The probability is computed by determining the number of available shared protection channels existing in the link and assigning this value to M, as in step 210, creating a set of N SRGs traversed by the primary to be protected and labeling them as SRGⱼ where 1<j<N, as in step 220, assigning the value of the number of times SRGⱼ is protected by the shared protection channel set in the link to nⱼ, as in step 230, computing the probability, p, that any one shared protection channel is shareable as p=Πⱼ(1-nⱼ/M), as in step 240, and computing the probability, P, that at least one shared protection channel is shareable as P=1−(1-Πⱼ(1-nⱼ/M))M^{M}, as in step 250.

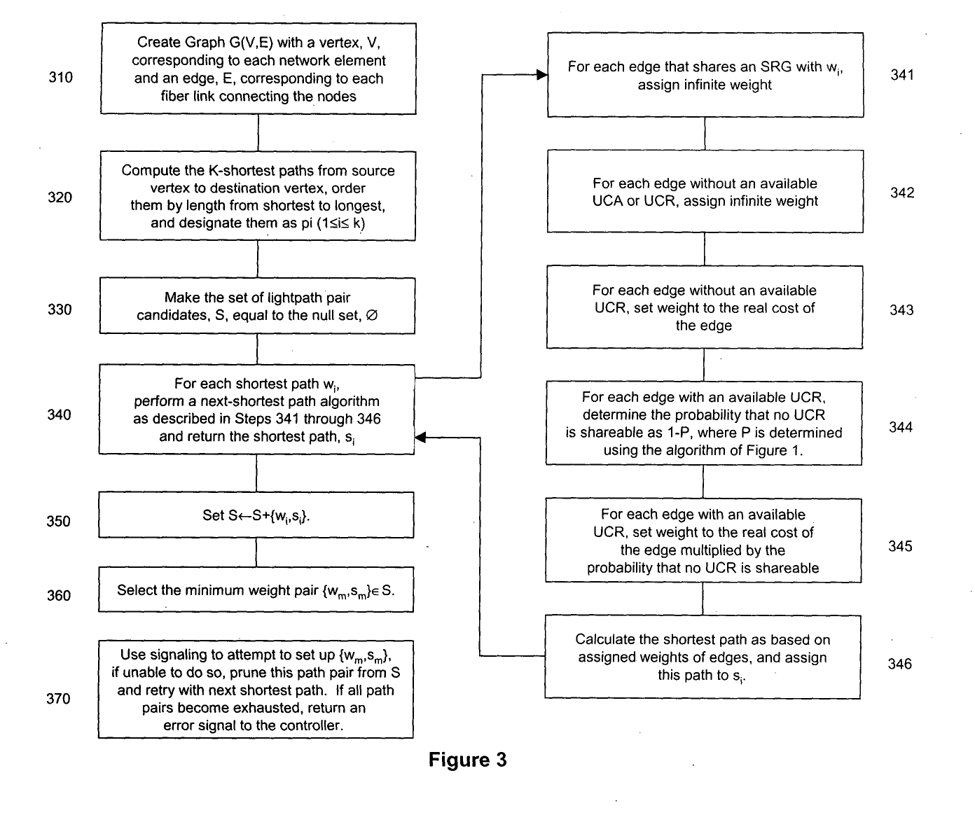

In another embodiment of our invention, a graphical method of provisioning primary and backup paths is used as described in FIG. 3. The steps of our inventive method include creating a graph G(V,E) wherein each network element in the network is represented by a vertex, V, each bi-directional link between adjacent network elements is represented by an edge, E, and a source vertex corresponding to the ingress network element and a destination vertex corresponding to the egress network element are defined as in step 310. Further steps include calculating a set of K shortest paths from ingress network element to egress network element through the network, ordered by length, and designated as potential primary paths wᵢ, where i ranges from 1 to K as in step 320, initializing the set of candidate path pairs, S, equal to the null set, Ø, as in step 330, determining a second shortest path corresponding to each first shortest path, wᵢ, between ingress network element and egress network element to be designated as the protection path, sᵢ, and returning a candidate pair of paths, {wᵢsᵢ}, as in step 340.

The candidate pair of paths is determined by setting the weight for each edge that shares an SRG with wᵢ, ∞, as in step 341, setting the weight for each edge that has neither shared protection channel nor unassigned primary channel to ∞, as in step 342, setting the weight of each edge without a shared protection channel to the actual cost of the edge, as in step 343, using the probability method shown in FIG. 2, as in step 344, setting the weight of each edge with at least one shared protection channel to the real cost of the edge scaled by the probability that no shared protection channel is shareable as determined in as in steps 210 to 250 of FIG. 2, as in step 345, calculating the shortest potential backup path associated with wᵢ and assigning it to path sᵢ, as in step 346, adding the minimum weight path pair {wi,si} to the set of potential path pair candidates, S, as in step 350, selecting the minimum weight pair {wₘ,sₘ} from the set S, as in step 360, using signaling between the ingress network element and all other network elements in wₘ and sₘ to establish the links comprising the paths, eliminating this pair from S and returning to Step 360 to select a new minimum weight pair {wₘ,sₘ} from set S if any link in the paths can not be provisioned, continuing until primary and backup paths are successfully provisioned, or S is exhausted, and returning an error signal to the client equipment requesting service if S becomes exhausted, as in step 370.

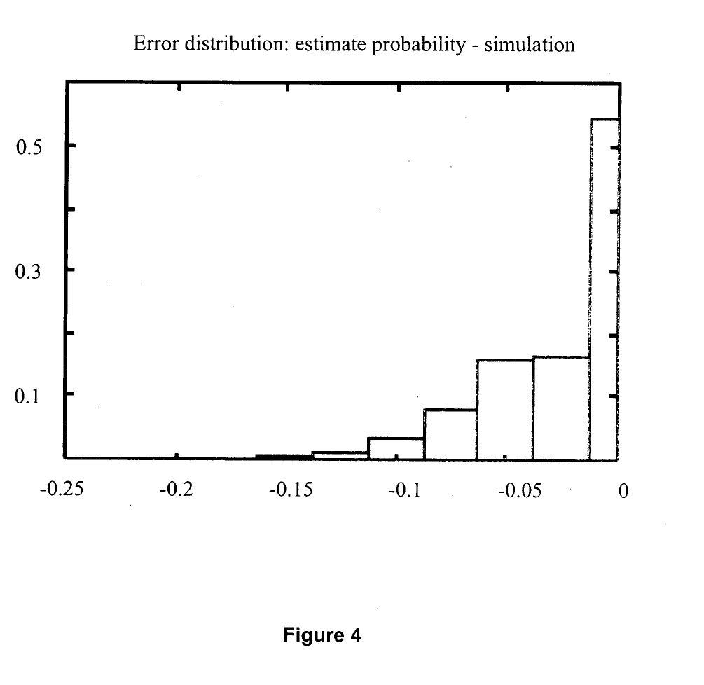

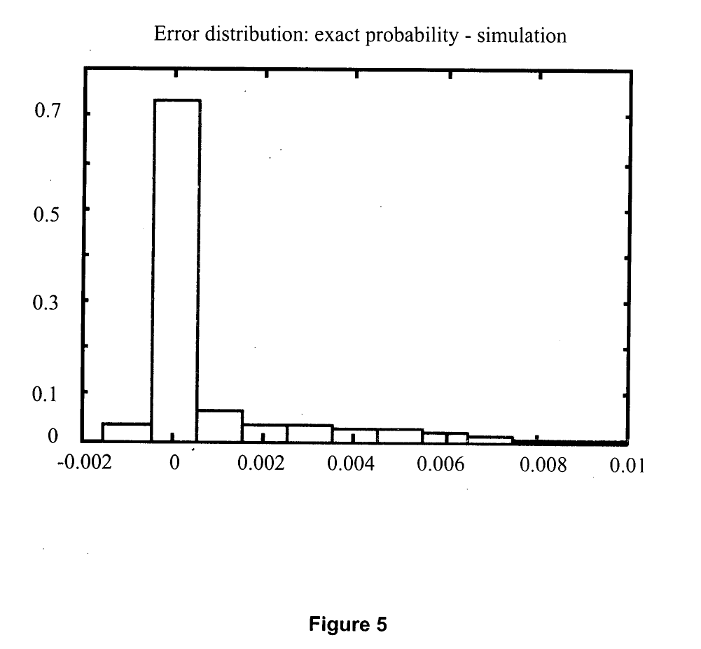

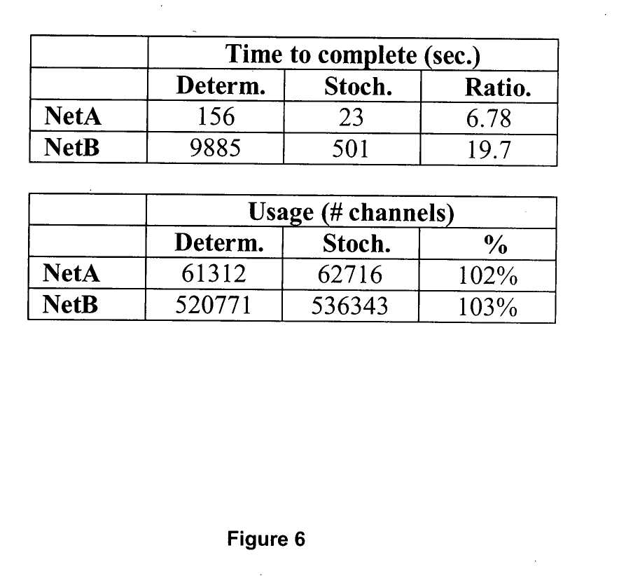

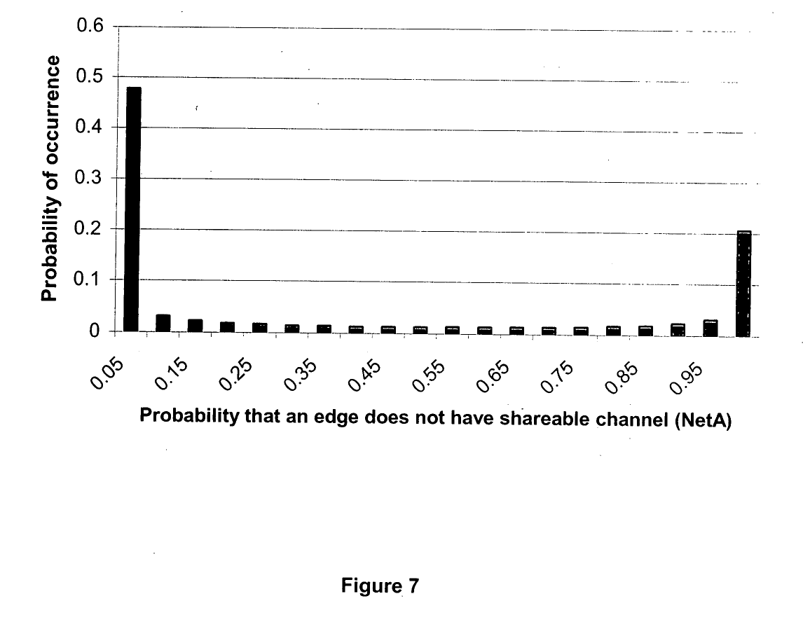

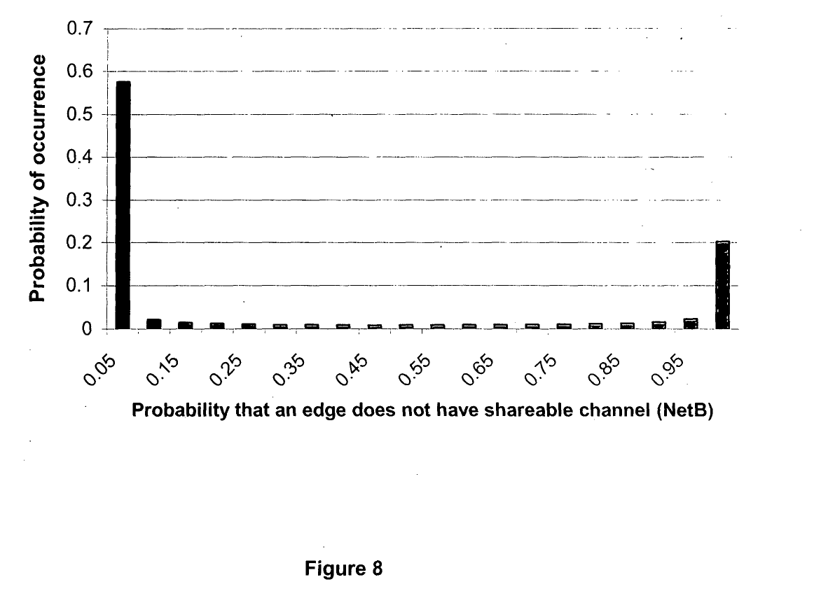

Experimental verification of our inventive method through simulation and experimentation on an optical network is shown in FIG. 4, FIG. 5, FIG. 6, FIG. 7, and FIG. 8. Qualitatively, the complexity of our stochastic method is the product of the number of SRGs traversed by the primary path, N, and the probability of any single path being sharable, p, raised to the power of the number of shared protection channels in a link, M. Note that the complexity is independent of the number of paths in the entire network, and the computation can be realized in O(N+logM) time.

The results obtained with our stochastic method and distributed control are in sharp contrast to those obtained using a deterministic method and centralized control in that the latter method has both time and space complexity dependent upon the number of paths in the network and therefore has difficulty scaling as the network grows.

The quality of the estimated probability that a link contains a shareable shared protection channel given the information on the number of times each SRG traversed by the primary path is restored in that link can be experimentally verified. The experiment consists of simulating several millions of random arrangements, and compute the ratio of combinations with available shared protection channels to the number of combinations without available shared protection channels. The difference between each experimental probability and the corresponding exact and approximate probabilities obtained by computation is then compared. FIG. 4 shows the error distribution of the estimate probabilities minus experimental probabilities obtained over the range of problem instances. FIG. 5 shows the error distribution of the exact probabilities obtained through direct computation. We observe that the estimate probability has a tendency to underestimate the experimental probability, but it is accurate within 0.05 for 85% of the time, which quite remarkable given the simplicity of its computation. In comparison, the simulation exhibits an accuracy within 0.01 of the exact probability, and a closer look indicates that 70% of the time the difference is within 5×10⁻⁴.

As can be readily appreciated by those skilled in the art, our invention advantageously produces highly efficient network usage such as that computed using a centralized control scheme, but with much faster computation times associated with distributed control architectures. As evidence of the computation time advantage, we consider two scenarios inspired from real life networks. NetA is a 100-node, 137-edge network, with one unit of demand between every pair of node (4950 demands). NetB is 220-node, 300-edge network, also with one unit of demand between every pair of node (24090 demands.) For the sake of simplicity we assume that every edge costs one unit of currency and corresponds to one SRG (i.e. one SRG per edge and one edge per SRG). We then route the demands on each network using the deterministic and the stochastic methods. We are interested here in the processing time to complete each method, and the quality of the solutions expressed in total number of channels required (used for primaries and reserved for backups.) The results are summarized in FIG. 6. For NetA (resp. NetB) we observe that the stochastic approach is 6.78 time faster (resp. 19.7 time faster) than the deterministic approach while the penalty is only 2% (resp. 3%) more capacity. Also important is the amount of information the route computation module (RCM) needs to compute the routes. The stochastic based RCM only require one array per edge, where each entry indicates the number of times the SRG is protected in the edge by any reserved channel. In the NetB problem they are thus 300 such arrays (one per edge) of 300 entries each (one per SRG). For comparison, the deterministic approach needs an array for each reserved channel, where each entry corresponds to an SRG and indicates whether the SRG is protected or not by the reserved channel. In NetB 213052 of the channels are reserved for protection, thus 213052 arrays of 300 entries each are required.

FIGS. 7 and 8 show the distribution of sharing probabilities as computed by the stochastic method during the provisioning of the demand in NetA and NetB. The distribution in FIG. 7 shows that the probability of having a sharable channel was essentially zero (<0.05) 48% of the time and essentially 1.0 for over 20% of the time. Therefore, it was possible to determine with near certainty the availability of a sharable reserved channel in NetA approximately 70% of the time. FIG. 8 shows somewhat improved results with near certainty approximately 77% of the time.

It will be understood that the embodiments of the present invention specifically shown and described are merely exemplary and that a person skilled in the art can make alternate embodiments using different configurations and functionally equivalent components. All such alternate embodiments are intended to be included in the scope of this invention as set forth in the following claims.

1. A method of selecting paths comprising the steps of:
a) computing a plurality of first shortest paths from a source point to a destination point each including of a serial chain of at least one communications link;
b) selecting K first shortest paths from the plurality;
c) ordering the selected K first shortest paths from shortest to longest;
d) for each first shortest path of K,
i) computing the cost of the first shortest path as substantially equal to the combined cost of the links included in the first shortest path;
ii) selecting a lowest estimated cost second shortest path from the remainder of the elements of K, where the estimated cost of the second shortest path is computed as substantially equal to the combined estimated cost of the links included in the second shortest path and the cost of a link corresponds to the cost of using the link scaled by a probability that the link can be shared by the second shortest path and a path already provisioned using a channel of the link;
e) selecting the lowest estimated combined cost first and second shortest path pair.

2. The method according to claim 1, wherein for a second shortest path, the cost of a link is estimated by;
a) assigning an infinite cost to a link included in an associated first shortest path;
b) assigning an infinite cost to a link that traverses at least one shared-risk-group (SRG) traversed by an associated first shortest path;
c) assigning to a link not having an available shared protection channel a cost substantially equal to the cost of allocating an additional shared protection channel to the link;
d) estimating for a link having at least one available shared protection channel a cost corresponding to the cost of using the link scaled by a probability that the link can be shared by the second path under consideration and no backup paths already provisioned using the link.

3. The method of claim 2 wherein the probability that the link can be shared by the second path under consideration and no backup path already provisioned using the link is determined according to a method comprising;
a) creating a variable M, and assigning as its value the number of available shared protection channels in the link;
b) for each j from 1 to N;
i) creating an array of N elements, SRGⱼ consisting of the N SRGs traversed by a proposed primary path;
ii) creating an array of N elements, nⱼ, consisting of the number of times SRGⱼ is traversed by a primary path protected by a backup path already provisioned using channels of the link;
c) computing a probability, p, that one available shared protection channel of a link can be shared by a second shortest path and one backup path already provisioned using the channel as p=Πⱼ(1-nⱼ/M), for j from 1 to N;
d) computing a probability, P, that no available shared protection channel of a link can be shared by a second shortest path with a backup path already provisioned using a channel of the link as P=(₁-p)^{M}.

4. The method according to claim 1, wherein the lowest cost path pair is selected according to a method comprising;
a) defining an array of K elements, wᵢ, where i ranges from 1 to K, including the ordered K first selected paths;
b) defining an array of K elements, si, where i ranges from 1 to K, including the K second shortest paths associated with the ordered K first selected paths;
c) defining a set, K, comprised of elements {wi,si}, where i ranges from 1 to K;
d) computing the combined estimated cost of the elements of set K, and ordering the elements from lowest combined estimated cost to highest combined estimated cost;
e) selecting the lowest combined estimated cost path pair in set K.

5. A method of selecting paths comprising the steps of:
a) creating a first graph representing a network having a topology containing network elements interconnected by communications links wherein each network element is represented by a vertex and each communication link interconnecting adjacent network elements is represented by an edge, the first graph containing a source vertex corresponding to an ingress network element and a destination vertex corresponding to an egress network element;
b) using the first graph to calculate a plurality of paths between the source and destination vertices;
c) selecting K first shortest paths between source vertex and destination vertex;
d) for each first shortest path;
i) computing the cost of the first shortest path;
ii) creating a second graph substantially based on the first graph wherein the second graph includes edges and estimated edge costs and an edge associated with the first shortest path is modified from the first graph;
iii) selecting a lowest estimated cost second shortest path from source vertex to destination vertex from the second graph wherein the estimated cost of the second shortest path is substantially equal to the combined estimated costs of the edges comprising the second shortest path and the estimated cost of an edge corresponds to the cost of using the edge scaled a probability that the edge can be shared by the second shortest path and a path already provisioned using a channel of the edge;
e) selecting the lowest estimated combined cost first and second shortest path pair.

6. The method according to claim 5 wherein an edge associated with the first shortest path is modified by removing it from the second graph.

7. The method according to claim 5 wherein an edge associated with the first shortest path is modified by setting its estimated edge cost to a very high value.

8. The method according to claim 5 wherein an edge associated with the first shortest path is modified by setting its estimated edge cost to an infinite value.

9. The method according to claim 5 wherein the K first shortest paths are ordered from lowest cost to highest cost and assigned to elements wᵢ, of set K, where i ranges from 1 to K.

10. The method according to claim 5, wherein for each first shortest path a least estimated cost second shortest path is chosen from the second graph and for each second shortest path in a second graph, the cost of a link is estimated according to a method comprising;
i) assigning an infinite cost to an edge that traverses at least one SRG traversed by the first shortest path;
ii) assigning to an edge without an available shared protection channel a cost substantially equal to the cost of adding an additional shared protection channel to the edge;
iii) estimating for an edge having at least one available shared protection channel a cost corresponding to the cost of using the edge scaled by a probability that the edge can be shared by the second path under consideration and no backup paths already provisioned using the edge.

11. The method of claim 10 wherein a probability that an edge can be shared by a second shortest path and no backup paths already provisioned using channels of an edge is estimated by;
a) creating a variable, M, and setting its value to the number of available shared protection channels in the edge;
b) for each j, where j ranges from 1 to N;
i) creating an array of N elements, SRGⱼ, consisting of the N SRGs traversed by a proposed primary path;
ii) creating an array of N elements, nⱼ, each consisting of the number of times SRGⱼ is traversed by a primary path protected by a backup path already provisioned using channels of the edge;
c) computing a probability, p, that one available shared protection channel of an edge can be shared by a second shortest path and one backup path already provisioned using the channel as p=Πⱼ(1-nⱼ/M);
d) computing a probability, P, that no available shared protection channel of an edge can be shared by a second shortest path with a backup path already provisioned using a channel of the edge as P=(1-p)^{M}.

12. The method of claim 5, wherein a lowest estimated combined cost first and second shortest path pair is selected according to a method comprising;
a) creating a set, S, with K elements {wᵢ,sᵢ}, where i ranges from 1 to K, including the K first shortest paths, wᵢ, and K associated selected second shortest paths, sᵢ;
b) for each first shortest path, wᵢ, where i ranges from 1 to K;
i) computing a cost substantially equal to the combined cost of the links included in the first shortest path;
ii) computing an estimated cost for the associated selected second shortest path substantially equal to the combined estimated cost of the links comprising the selected second shortest path;
c) ordering the elements of set S from lowest combined estimated cost to highest combined estimated cost;
d) selecting the lowest combined estimated cost path pair.

13. A shared mesh protection network wherein paths are provisioned according to a method comprising;
a) generating a list of at least one candidate pair of paths including one primary path and one associated backup path between a source network element and a destination network element;
b) selecting a lowest estimated path pair from the list where the cost of the primary path is substantially equal to the cost of the network resources included in the primary path and the estimated cost of a backup path corresponds to the cost of the network resources included in the backup path scaled by the probability that existing network resources can be shared by the backup path;
c) using signaling to attempt to establish the selected path pair;
d) eliminating the selected path pair from the list if it can not be established and attempting to establish a new lowest estimated cost path pair;
e) returning an error signal to a network operator if no candidate path pair from the list can be allocated.

14. The network of claim 13 wherein path provisioning is controlled by the source network element and signaling is used between the source network element and each network element in a proposed pair of primary and backup paths to establish links between adjacent network elements.

15. The network of claim 14, wherein said signaling is comprised of the steps of;
a) for each network element in the primary path, sending from the source network element to the network element a request for the network element to establish a link with adjacent network elements;
b) for each network element in the backup path, sending from a source network element to the network element a request for the network element to establish a link with adjacent network elements;
c) for each network element in the primary path that can not establish a link to an adjacent network element, sending from the network element to the source network element an error signal;
d) for each network element in the primary path that can establish a link to an adjacent network element, sending from the network element to the source network element a valid link signal;

16. The network of claim 13 wherein the network has a single network controller and signaling between the controller and network elements is used to provision primary and backup paths.

17. The network of claim 13, wherein reallocation of existing network resources is initiated at any time.

18. The network of claim 13, wherein reallocation of existing network resources is initiated at each request of new communications service.

19. The network of claim 13, wherein reallocation of existing network resources is initiated at regularly scheduled intervals.
